(19) United States
(12) Patent Application Publication
(10) Pub. No.: US 2017/0055489 A1
(43) Pub. Date: Mar. 2, 2017

(54) LIFTING AND OVERTURNING TYPE AUTOMATICALLY-LOCKED PET CAGE DOOR

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/246,509

(22) Filed: Aug. 24, 2016

(30) Foreign Application Priority Data
Aug. 24, 2015 (CN) 201520642568.3

(51) Int. Cl. A01K 1/02; E06B 3/44; E05F 11/54; E06B 3/50

(52) U.S. Cl. CPC A01K 1/0245; E06B 3/5063; E06B 3/509; E06B 3/44; E05F 11/54

(57) ABSTRACT

A lifting and overturning type automatically-locked pet cage door includes a lifting handle, a hook shift liver, a spring, a rotting shaft and a pair of guide rails. The lifting handle is rotatably fixed on the upper end of a door body, and the hook shift lever is fixed on a crossbar above the door body; when the cage door is closed, the hook shift lever hooks the upper end of the door body under the action of the spring to realize locking; when the cage door is opened, the door body slides upwards along a pair of guide rails to drive the hook shift lever to rotate, and slides upwards to the maximum displacement position after being separated from the hook shift lever, and the door body rotates along the rotating shaft and is laid on the top of the pet cage.

### CROSS-REFERENCE TO RELATED APPLICATIONS

This Application claims the priority of Chinese Patent Application No. 201520642568.3, filed on Aug. 24, 2015, the disclosure of which is incorporated by reference in its entirety.

### TECHNICAL FIELD

The present invention relates to a pet cage door, in particular to a lifting and overturning type automatically-locked pet cage door, belonging to the technical field of pet cages.

### BACKGROUND ART

Regarding the existing metal (e.g., iron) wire mesh cage for pet raising, a door capable of being opened and closed is disposed on one side of the cage, and the door is generally of a rotating type or a sliding type; regardless of the rotating type or the sliding type, the door is generally locked via a bolt; during use, the bolt is capable of moving left and right or up and down in need of manpower, and is thus inconvenient to operate, and is relatively laborious to operate especially in case that the iron wire mesh cage is rusted a litter or insufficient to lubricate. In addition, as an independent part, the bolt is not integrated with the whole pet cage and is even separated from an iron wire hole sometimes, and the phenomenon of bolt lost brings unnecessary troubles to users; moreover, regardless of the rotating type or the sliding type, the existing pet cage door needs to occupy a certain external space when being opened, and is thus relatively inconvenient to open and close owing to the limit of the space condition.

### SUMMARY OF THE INVENTION

The technical problem to be solved by the present invention is that: the existing sliding door of a metal (e.g., iron) wire pet cage is inconvenient to operate and relatively laborious, and a bolt may be even separated from an iron wire hole sometimes, resulting in a phenomenon of bolt lost; the door needs to occupy a certain external space when being opened, and is thus relatively inconvenient to open and close owing to the limit of the space condition.

Objects of the present invention may be realized in the following manners:

a lifting and overturning type automatically-locked pet cage door comprises a lifting handle 1, a hook shift lever 2, a spring 3, a rotating shaft 4 and a pair of guide rails 5; the lifting handle 1 is rotatably fixed on the upper end of a door body, and the hook shift lever 2 is fixed on a crossbar above the door body; when the cage door is closed, the hook shift lever 2 hooks the upper end of the door body under the action of the spring 3 to realize locking; and when the cage door is opened, the door body slides upwards along a pair of guide rails 5 to drive the hook shift lever 2 to overcome the elastic force of the spring 3 to rotate, and slides to the maximum displacement position upwards after being separated from the hook shift lever 2, and the door body rotates along the rotating shaft 4 and is laid on the top of the pet cage.

Further, the spring 3 is a torsional spring.

Further, the pair of guide rails 5 is vertically positioned on both sides of the door body.

Further, the door body is rectangular.

Further, the guide rails 5 are square guide rails.

Embodiments of the present invention may have one or more of the following beneficial effects:
1) The lifting and overturning type automatically-locked pet cage door is capable of realizing automatic unlocking and very labor-saving to operate.
2) Actions of unlocking and opening the door of the pet cage are coherent and convenient to operate.
3) No bolt needs to be used, so that parts of the bolt are reduced, and the phenomenon of lost of parts cannot happen.
4) The guide rails on both sides are capable of sliding up and down, so that the space is saved.
5) When the pet cage door is opened, the door body can be flatly laid on the upper part of the cage, so that the space is saved, and thus the cage door is more convenient to be opened and closed.

### BRIEF DESCRIPTION OF THE DRAWINGS

FIG. 1 is a schematic drawing of the pet cage when the lifting and overturning automatically-locked pet cage door disclosed by the present invention is closed.

FIG. 2 is a partial enlarged drawing of FIG. 1.

FIG. 3 is a partial enlarged drawing of FIG. 2.

FIG. 4 is a schematic drawing of the pet cage when the lifting and overturning type automatically-locked pet cage door is opened.

FIG. 5 is a partial enlarged drawing of FIG. 4.

In FIGs., the lifting handle 1, the hook shift lever 2, the spring 3, the rotating shaft 4 and a pair of guide rails 5 are marked.

### DETAILED DESCRIPTION

The present invention is further illustrated as below in conjunction of attached drawings and specific embodiments.

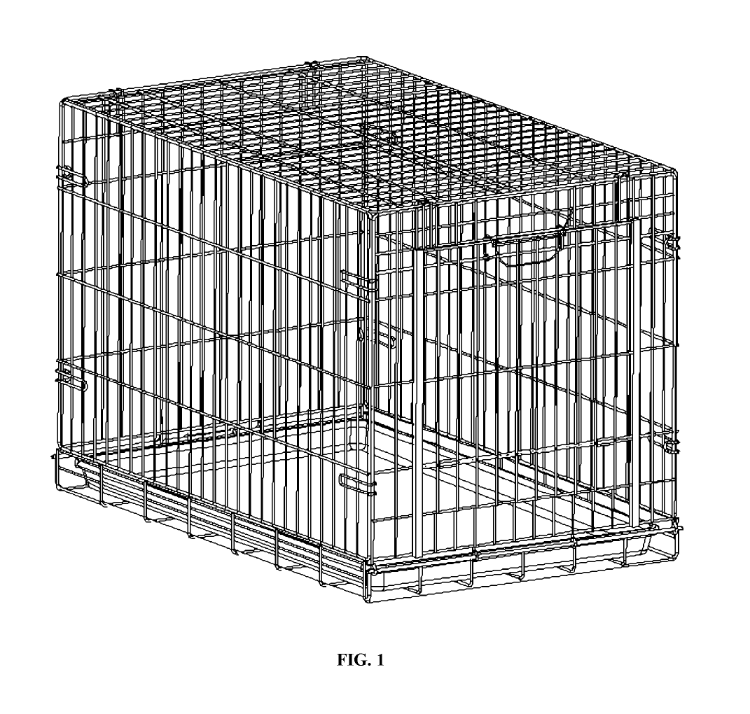

By reference to FIG. 1 to FIG. 5, a lifting and overturning type automatically-locked pet cage door comprises a lifting handle 1, a hook shift lever 2, a spring 3, a rotating shaft 4 and a pair of guide rails 5; the lifting handle 1 is rotatably fixed on the upper end of a door body, and the hook shift lever 2 is fixed on a crossbar above the door body; when the cage door is closed, the hook shift lever 2 hooks the upper end of the door body under the action of the spring 3 to realize locking; and when the cage door is opened, the door body slides upwards along a pair of guide rails 5 to drive the hook shift lever 2 to overcome the elastic force of the spring 3 to rotate, and slides to the maximum displacement position upwards after being separated from the hook shift lever 2, and the door body rotates along the rotating shaft 4 and is laid on the top of the pet cage.

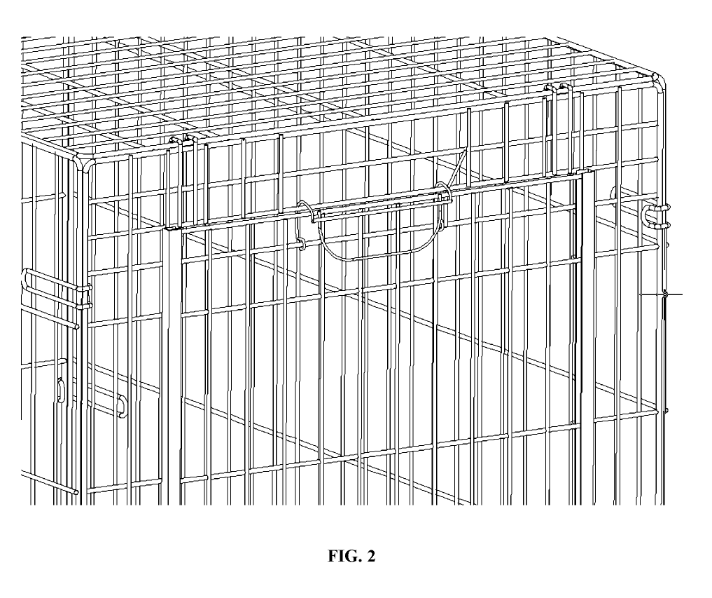

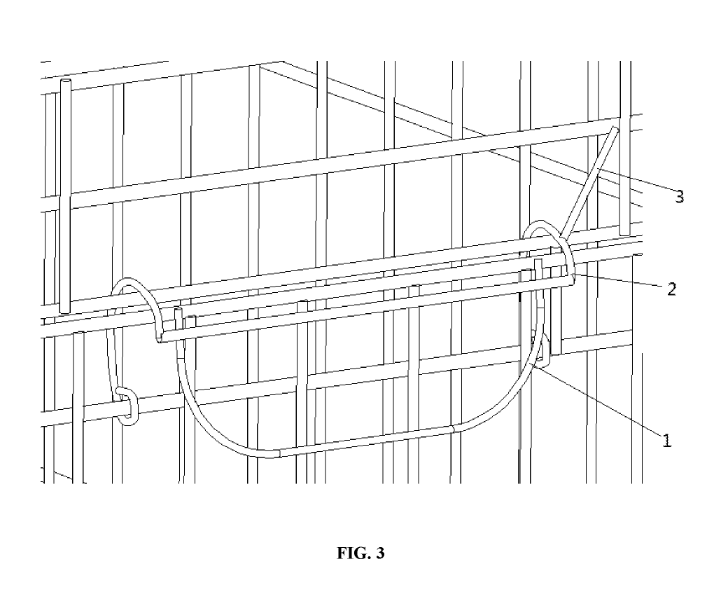

By reference to FIG. 2 to FIG. 3, the spring 3 may be a torsional spring.

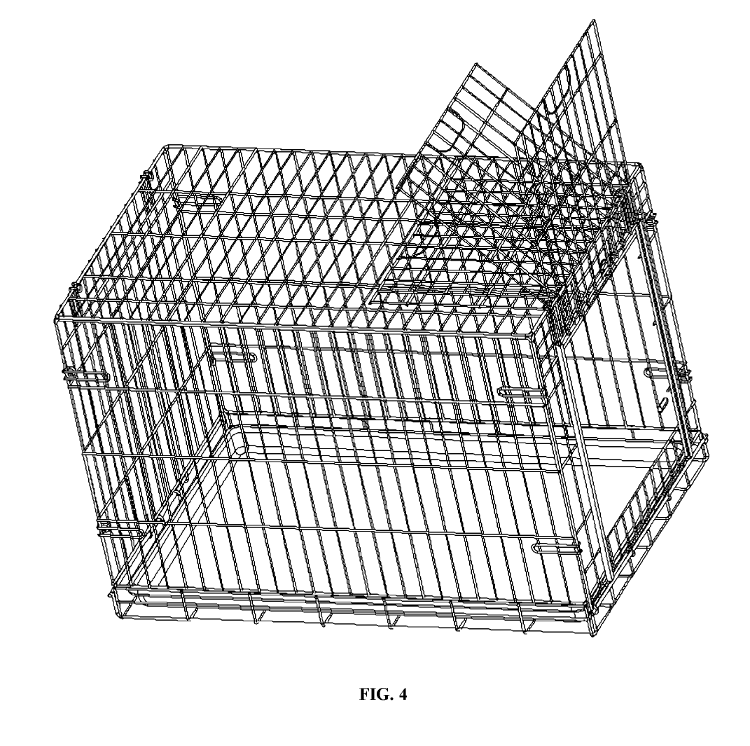

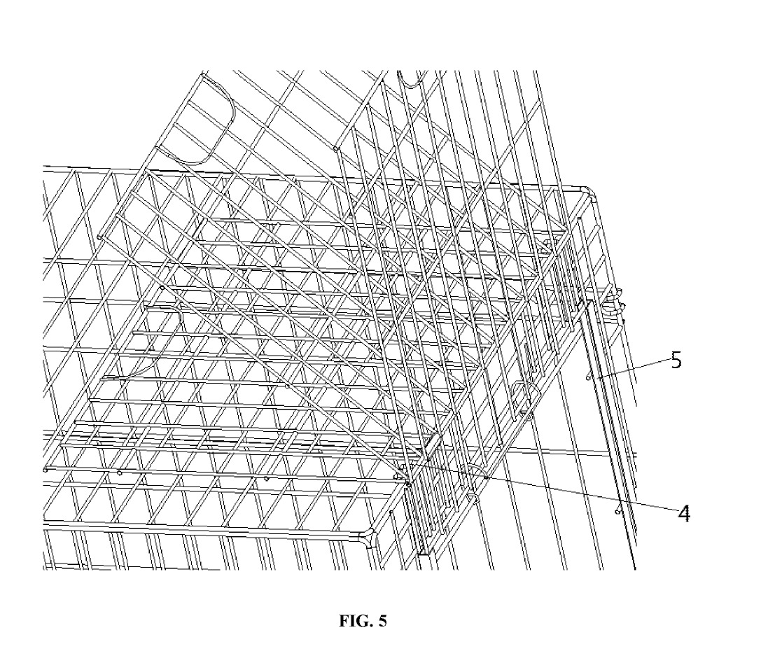

By reference to FIG. 4 to FIG. 5, the pair of guide rails 5 may be vertically positioned on both sides of the door body.

By reference to FIG. 1 and FIG. 4, the door body may be rectangular.

By reference to FIG. 2 and FIG. 5, the guide rails 5 may be square guide rails.

The lifting and overturning type automatically-locked pet cage door disclosed by the present invention is capable of realizing automatic unlocking and very labor-saving to operate; actions of unlocking and opening the door of the pet cage are coherent and convenient to operate; no bolt needs to be used, so that parts of the bolt are reduced, and the phenomenon of lost of parts cannot happen; the guide rails on both sides are capable of sliding up and down, so that the space is saved; when the pet cage door is opened, the door body can be flatly laid on the upper part of the cage, so that the space is saved, and thus the cage door is more convenient to be opened and closed.

What is claimed is:

1. A lifting and overturning type automatically-locked pet cage door, comprising:
a lifting handle (1);
a hook shift lever (2);
a spring (3);
a rotating shaft (4); and
a pair of guide rails (5),
wherein the lifting handle (1) is rotatably fixed on the upper end of a door body, and the hook shift lever (2) is fixed on a crossbar above the door body;
wherein when the cage door is closed, the hook shift lever (2) hooks the upper end of the door body under the action of the spring (3) to realize locking; and
wherein when the cage door is opened, the door body slides upwards along a pair of guide rails (5) to drive the hook shift lever (2) to overcome the elastic force of the spring (3) to rotate, and slides to the maximum displacement position upwards after being separated from the hook shift lever (2), and the door body rotates along the rotating shaft (4) and is laid on the top of the pet cage.

2. The lifting and overturning type automatically-locked pet cage door according to claim 1, wherein the spring (3) is a torsional spring.

3. The lifting and overturning type automatically-locked pet cage door according to claim 1, wherein the pair of guide rails (5) are vertically positioned on both sides of the door body.

4. The lifting and overturning type automatically-locked pet cage door according to claim 1, wherein the door body is rectangular.

5. The lifting and overturning type automatically-locked pet cage door according to claim 1, wherein the guide rails (5) are square guide rails.
